(19) United States
(12) Patent Application Publication
(10) Pub. No.: US 2026/0318826 A1
(43) Pub. Date: Oct. 15, 2026

(54) COMPACT DEEP ULTRAVIOLET MICROSCOPE

(71) Applicant: The Texas A&M University System, College Station, TX (US)

(72) Inventors: Dinesh Dhankhar, Beaverton, OR (US); Peter M. Rentzepis, College Station, TX (US)

(21) Appl. No.: 19/107,470

(22) PCT Filed: Aug. 30, 2023
(86) PCT No.: PCT/US2023/073173

§ 371 Date: Feb. 27, 2025

Related U.S. Application Data
(60) Provisional application No. 63/402,166, filed on Aug. 30, 2022.

(51) Int. Cl. G01N 21/33; G01N 21/64

(52) U.S. Cl. CPC G01N 21/33; G01N 21/6458; G01N 2021/6478

(57) ABSTRACT

Compact and affordable microscopes for ultraviolet microscopy, in particular in the deep ultraviolet region, can be constructed using narrowband ultraviolet light sources such as, e.g., ultraviolet LEDs, ultraviolet-transmissive lenses made from fused silica or quartz, and ultraviolet-sensitive detectors. Suitable detectors include CCD or CMOS sensors without ultraviolet-blocking layers, a fluorescent screen imaged by a visible-light camera, photographic paper, or cyanotype-coated paper.

### CROSS-REFERENCE TO RELATED APPLICATION

This application claims priority to and the benefit of U.S. Provisional Application No. 63/402,166, filed on Aug. 30, 2022, which is incorporated herein by reference in its entirety.

### GOVERNMENT LICENSE RIGHT

This invention was made with government support under Grant Nos. FA9550-20-1-0139 and FA9550-22-0148, both awarded by the Air Force Office of Scientific Research (AFOSR). The government has certain rights in this invention.

### BACKGROUND

Microscopy in the ultraviolet spectral region provides various advantages over microscopy in the visible region. One advantage lies in the higher spatial resolution that can be achieved with the shorter-wavelength ultraviolet radiation. Another benefit, which applies, in particular, to the observation and recording of biological species, is the higher contrast provided in the deep ultraviolet region (corresponding, as herein understood, to wavelengths of less than 300 nm) due to the fact that important biological molecules, such as proteins, DNA, RNA, and others, have a strong absorption in the deep ultraviolet region. However, there are presently very few optical microscopes commercially available that are capable of imaging such molecules in the deep ultraviolet, and those that are available tend to be of large size and prohibitively expensive (e.g., costing thousands or tens of thousands of dollars). Accordingly, there is a need for smaller, more affordable deep ultraviolet microscopes suitable for biological molecules and species.

### BRIEF DESCRIPTION OF THE DRAWINGS

Various compact and affordable deep ultraviolet microscopy systems are described herein with reference to the following drawings:

FIG. 1A is a schematic diagram of an example deep ultraviolet microscopy system utilizing an electronic image sensor, in accordance with various embodiments.

FIG. 1B is a drawing illustrating an example modified microscope equipped with an electronic image sensor, in accordance with various embodiments.

FIGS. 2A and 2B are images of biological species captured with a monochrome CCD sensor of an example ultraviolet microscopy system operating at a wavelength of 275 nm.

FIG. 3A is an image, taken under 275 nm illumination, of a webcam sensor with the Bayer and other filter layers partially removed.

FIG. 3B is a graph showing the spectral sensitivity to ultraviolet light of the webcam sensor of FIG. 3A with the filter layers removed, compared with the spectral sensitivity of the webcam sensor with the filter layers present and intact.

FIG. 4A is a schematic diagram of an example deep ultraviolet microscopy system utilizing a fluorescent screen in conjunction with an electronic image sensor sensitive in the visible regime, in accordance with various embodiments.

FIG. 4B is an image of unlabeled cheek cells, taken with an example ultraviolet microscopy system including a fluorescent screen imaged with a cellphone camera.

FIG. 4C is a schematic diagram of a compact example deep ultraviolet microscopy system utilizing a fluorescent screen placed adjacent to the sample in conjunction with an electronic image sensor sensitive in the visible regime, in accordance with various embodiments.

FIGS. 5A-5H show images (FIGS. 5A, 5C, 5E, 5G) and associated line profiles (FIGS. 5B, 5D, 5F, 5H) of a fused-quartz USAF1951 resolution target, acquired with ultraviolet microscopy systems utilizing as its respective detectors a CCD sensor, a CMOS webcam sensor stripped of its filter layers, a cellphone camera imaging a fluorescent screen, and photographic paper, in accordance with various embodiments.

### DESCRIPTION

Disclosed herein are compact microscopy systems that operate in the deep ultraviolet region of the electromagnetic spectrum and are capable of recording micrometer-size biological species and molecules. In various embodiments, low-cost microscopes conventionally operating in the visible regime are equipped or retrofitted with modified light sources, detectors, and/or optics to enable high-contrast imaging of micro-size samples in the deep ultraviolet regime, e.g., in the range from 200-300 nm.

There are several contributing factors to the lack of affordable deep-ultraviolet microscopes in the market. First, traditional glass lenses cannot be used because of their strong absorption of ultraviolet light. Second, there are only few sufficiently bright deep ultraviolet light sources, and those are hard to operate and maintain safely, require high power to operate, and/or pose other limitations to their use with biological systems. For example, the most common deep ultraviolet light source, mercury vapor lamps, pose a health hazard when operating and must be disposed safely when they break. As another example, excimer deep ultraviolet lasers, which are routinely employed by the semiconductor industry in deep ultraviolet lithography, are bulky and not easily portable, and their typical emission lines, at 193 nm and 157 nm, are not well suited for biological molecules, whose absorption lines are generally in the 200-300 nm range (e.g., 260 nm for DNA/RNA and 280 nm for proteins). Third, traditional camera sensors, such as complementary metal-oxide-semiconductor (CMOS) and charge-coupled device (CCD) sensors come with various coatings and protective glasses that do not transmit UV light. The ultraviolet microscopes disclosed herein address some or all of these problems.

In some embodiments, one or more deep ultraviolet-light emitting diodes (LEDs) are used as the light source of the microscope. Beneficially, ultraviolet LEDs are inexpensive, energy-efficient, compact, and portable. They emit ultraviolet radiation within a narrow wavelength band, e.g., having a full width at half maxim (FWHM) of about 10-15 nm, and are available at center wavelengths ranging from 200 nm to 300 nm in the deep ultraviolet regime as well as at longer wavelengths, up to and including the visible regime. As such, ultraviolet LEDs provide bright light sources in the UVC (200 to 280 nm), UVB (280 to 320 nm), and UVA (320 to 400 nm) ranges. Utilizing narrowband LED sources has advantageous implications for the optics used in the system. As compared with recording images by employing a wide band of wavelengths simultaneously, using a narrow wavelength band can greatly reduce chromatic aberrations in the recorded image, which in turn reduces the requirements on the achromaticity of the microscope objective lens and/or other lenses in the light path, thereby simplifying the system. Any remaining non-chromatic aberrations can be corrected by software during the post-processing of the images.

Alternatively to LEDs, a narrowband deep ultraviolet source can also be provided by a deuterium or xenon lamp that is coupled to a monochromator. Deuterium lamps are characterized by high-intensity emission over a broad band from about 250 nm to about 350 nm. Xenon lamps emit radiation over an even broader spectral range, from about 200 nm in the ultraviolet regime through the visible and into the infrared regime. A monochromator may be used to spatially separate the different wavelengths, e.g., using a prism or diffraction grating, and to select a narrow band to exit the monochromator, e.g., through an exit slit in a screen that blocks the other wavelengths. In this manner, the broadband deuterium or xenon lamp in conjunction with the monochromator may serve as a narrowband deep ultraviolet light source, providing reduced chromatic aberration as discussed above. The monochromator may be equipped with a mechanism that allows mechanically scanning the narrow wavelength band over the broad spectrum of the lamp, e.g., by rotating the prism or grating. Note that, although a narrowband ultraviolet light source is beneficial due to the reduced chromatic aberration, the ultraviolet microscopy systems discussed herein are not limited to narrowband sources, but can in principle also utilize broadband ultraviolet light sources in some embodiments.

In various embodiments, the microscope is configured for transmitted light microscopy, and includes a system of ultraviolet-transmissive lenses, such as a collimator lens to collimate the light from the light source, a condenser lens to direct the collimated light onto the sample, and an objective lens and optional tube lens to image the sample onto the detector. In some embodiments, the detector or part of it is placed directly adjacent to the sample, and the objective and tube lenses are omitted. The lenses are made of fused silica or quartz, which are amorphous and crystalline forms, respectively, of almost pure silica (silicon dioxide), as distinguished from what we conventionally mean by “glass,” which is an amorphous material made from a mixture of silica and a high percentage (e.g., on the order of 30%) of other ingredients (such as limestone, sodium carbonate, and other additives). (When quartz is melted and cooled to form an amorphous solid, it is referred to “fused quartz” or “quartz glass.” Fused quartz is very similar to fused silica, although it may contain a small amount of impurities if formed from naturally occurring quartz. The terms “fused quartz” and “fused silica” are herein used synonymously.) Unlike glass, whose transmissivity falls off substantially in the ultraviolet regime towards lower wavelengths, fused silica and quartz are highly transmissive in the ultraviolet region, e.g., with transmission above 70% or 80% across the wavelength range from 200 nm to 400 nm. In addition, they are usable in the visible region. The lens system may include ball or half-ball lenses (e.g., in particular, for the collimator lens and objective lens), which are readily available at low cost and exhibit a relatively large numerical aperture, thereby providing a high-resolution image. The use of simple ball or half-ball fused-silica or quartz lenses is in part enabled by employing a narrowband ultraviolet light source that reduces chromatic aberrations.

Alternatively to fused-silica or quartz lenses, reflective optics (e.g., reflective microscope objectives), which do not suffer from chromatic aberrations and do not attenuate ultraviolet light, may in principle be used. Reflective optics can be used over a wide range of wavelengths. However, they tend to have a relatively small numerical aperture, which limits the resolution. In addition, the cost of reflective objectives tends to be high.

In some embodiments, the ultraviolet light transmitted through the sample is focused by an objective lens, or imaged by an objective lens and a tube lens (or more complex system of lenses), onto an electronic detector, such as a CCD or CMOS sensor. For example, a specialized monochrome ultraviolet-sensitive CCD sensor may be used.

Alternatively, commonly used CMOS detectors, such as those employed in commercially available web-cameras (hereinafter “webcams,” as they are commonly referred to), can be rendered sensitive to deep ultraviolet radiation by removing the infrared and ultraviolet light blocking filters and de-bayering the sensor (that is, removing the red, green, and blue layers of filters from the sensor). Layer removal can be achieved mechanically (e.g., by abrasion) or by dissolving the layers in appropriate chemicals.

In some embodiments, a fluorescent screen is used as part of the detector. The fluorescent screen may, for instance, include a thin plate (e.g., made of quartz or ultraviolet-transmissive polymer) with a coating of silver-activated zinc sulfide, ZnS:Ag, which fluoresces brightly when illuminated with deep ultraviolet light. Alternatively, in some embodiments, a simple sheet of white printer paper may be used as the fluorescent screen. The objective lens and tube lens of the microscope may project the sample onto the fluorescent screen, which in turn may be imaged with a camera operating in the visible range, such as a regular (unmodified) cellphone camera. As an alternative to imaging the sample onto the fluorescent screen, it is also possible to place the fluorescent screen directly adjacent to the sample. Either way, with detector configurations that utilize a fluorescent screen in conjunction with a cellphone camera, the ultraviolet microscope becomes very accessible, inexpensive, and compact.

Yet another type of embodiments utilizes photographic paper or film as an ultraviolet-sensitive detector because these papers, inherently, exhibit higher sensitivity to the blue and ultraviolet wavelength region than the longer-wavelength portions of the visible region. Photographic papers also provide a cost-effective and straightforward means for recording high-quality deep ultraviolet microscopic images. The photographic paper may be placed at the image plane of the microscope, replacing the electronic image sensor.

As an alternative to photographic paper, paper coated with cyanotype printing chemicals (e.g., potassium ferricyanide (K₃[Fe(CN)₆]³−) or ferrous ammonium citrate ((NH₄)₅[Fe(C₆H₄O₇)₂]), which also show high sensitivity in the ultraviolet region, may be used to record an image of the sample. The cyanotype-coated paper is, in these embodiments, placed in contact with the sample.

The various above-described system components and features can be used in various combinations to achieve, at low to moderate cost (e.g., on the order of hundreds of dollars), compact (e.g., handheld) microcopy systems for acquiring and recording microscopic images in the deep ultraviolet spectral regime (e.g., between 200 and 300 nm). The disclosed microscopes and microscopy system can be employed, in particular, for the detection of biological species and molecules, such as protein crystals, DNA/RNA, and pathogens like bacteria, viruses, and fungi, and are especially suited to in-field applications due to their portability and compactness.

Various example embodiments will now be described in more detail with reference to the accompanying drawings.

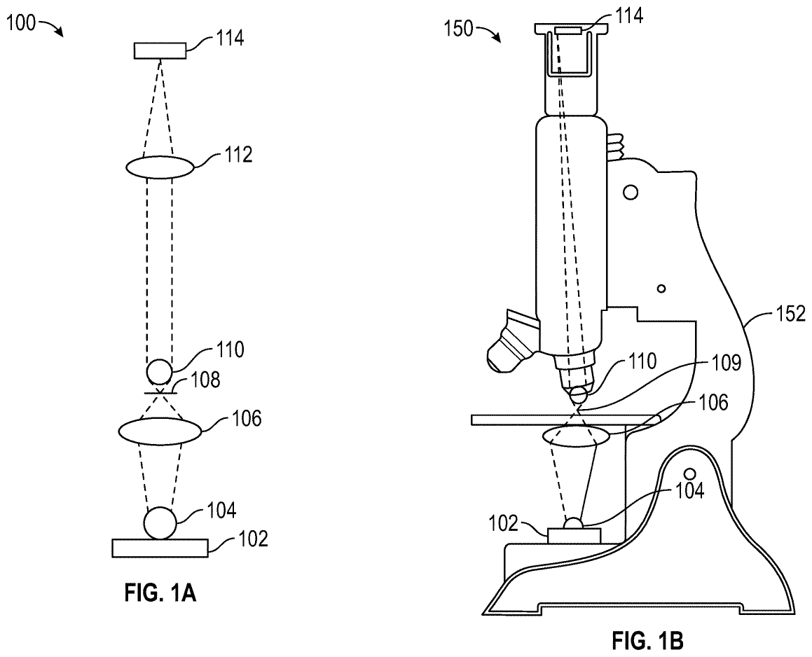

FIG. 1A is a schematic diagram of an example deep ultraviolet microscopy system 100 utilizing an electronic image sensor, in accordance with various embodiments. The system 100 includes a deep ultraviolet LED 102 that emits a narrow band of ultraviolet radiation, e.g., at a center wavelength of about 250 nm, 255 nm, 260 nm, or 275 nm. Such ultraviolet LEDs are commercially available, e.g., from Marktech Optoelectronics, Latham, New York, or from Thorlabs, Inc., Newton, New Jersey. For the experimental images and data described below, a 275 nm LED from Marktech Optoelectronics (Model MTSM275UV-F1120S) was used. The emitted light is first roughly collimated (e.g., such that an angle of divergence associated with the light beam is less than 5°) with a suitable collimating lens 104. The collimated ultraviolet light then passes through a condenser lens 106, which focuses the light onto a sample disposed on a sample substrate slide or stage (hereinafter simply “sample substrate”) 108. As shown, the sample may be illuminated from below, though the sample substrate 108, which may be, e.g., an ultraviolet-transmissive quartz or fused-quartz plate. Ultraviolet light transmitted through the sample is imaged by an objective lens 110 and a tube lens 112 onto the image sensor 114, where a magnified image of the sample is formed. The lenses 104, 106, 110, 112 are made of an ultraviolet-transmissive material such as fused silica or quartz. Some or all of the lenses 104, 106, 110, 112 may be ball or half-ball lenses, e.g., having diameters in the range of a few millimeters. For instance, in the depicted example, both the collimating lens 104 and the objective lens 110 are ball lenses. Ball and half-ball lenses are easily manufactured (compared with lenses having more complex shapes), and are therefore generally inexpensive. Suitable half-ball and ball lenses may be obtained, e.g., from Edmund Optics, Barrington, New Jersey, or from Thorlabs, Inc., Newton, New Jersey.

The image sensor 114 may be a CCD or CMOS sensor, configured to avoid absorption in the ultraviolet regime. For example, CCD sensors may be specially manufactured to be ultraviolet-sensitive monochrome sensors, e.g., sensitive to ultraviolet in a wavelength band that is between 50 and 100 nm wide. Alternatively, a CCD sensor that is sensitive to light over a broader wavelength range may be used in conjunction with suitable filters, e.g., to block visible and infrared light while detecting ultraviolet light. CMOS sensors may be obtained, without limitation, from webcams, modified to remove the ultraviolet-blocking filter layers, as discussed in more detail below. The microscopy system 100 further includes electronic circuitry (not shown) associated with the sensor 114 for reading out the sensor 114 and processing the acquired images. The processing circuitry may include one or more special-purpose processors, such as a digital signal processor (DSP), application-specific integrated circuit (ASIC), or field-programmable gate array (FPGA). Alternatively or additionally, the electronic circuitry may include a general-purpose processor to execute software programs or applications stored in processor-readable memory. Various software applications for image read-out and processing are commercially available. In the below examples, SharpCap, an astronomy camera software tool available, in free and paid versions, at https://www.sharpcap.co.uk, was used to capture and process the images.

FIG. 1B is a drawing illustrating an example modified microscope 150 equipped with an electronic image sensor 114, in accordance with various embodiments. The microscope 150 utilizes the body 152 of a simple straight-tube microscope (e.g., a Tasco LM400 microscope). Note that microscopes with tilted tubes, which are generally equipped with glass prisms to redirect the light, cannot be used for ultraviolet microscopy, due to the strong absorption of deep ultraviolet light by glass, unless the glass prism is replaced by an ultraviolet-transmissive or reflective optic. Simple straight-tube microscopes are usually supplied with a mirror to redirect ambient light to the sample. To modify the microscope for ultraviolet microscopy, this mirror may be removed, leaving ample space to insert a custom-made deep ultraviolet light source for transillumination of the sample, such as a deep ultraviolet LED emitting at 275 nm. The LED may be mounted on a heat sink. As depicted, a half-ball lens serving as the collimating lens 104 may be integrated with the LED 102; such ultraviolet LEDs with integrated half-ball lenses are readily commercially available. The collimated light passes through a condenser lens 106, which focuses the light through an ultraviolet-transmissive quartz plate or similar sample substrate 108 onto the sample 109, as discussed above with reference to FIG. 1A.

Ultraviolet radiation transmitted by the sample 109 is then focused by the objective lens 110 directly onto the image sensor 114; as shown in FIG. 1B, the tube lens 112 depicted in FIG. 1A may be omitted. The ball objective lens 110 may be installed on the microscope body 152 by embedding the lens in a plate and attaching the plate to the microscope objective lens shell (with all other internal optics removed). Ball lenses of different diameters provide different amounts of magnification. In example embodiments, a 4-mm-diameter half-ball lens or a 2-mm-diameter ball lens may be used for the objective lens 110. The CCD or CMOS image sensor 114 is usually small in size, and consequently, the field of view provided by an image formed by directly focusing the sample onto the sensor 114 tends to be small. To widen the field of view, a tube lens 112 (as shown in FIG. 1A), e.g., having a focal length of 50 mm, may be used to reduce the magnification. In example embodiments, a field of view of 288 μm×230 μm or of 110 μm×88 μm is achieved with a 4 mm half-ball objective lens or a 2 mm half-ball objective lens, respectively.

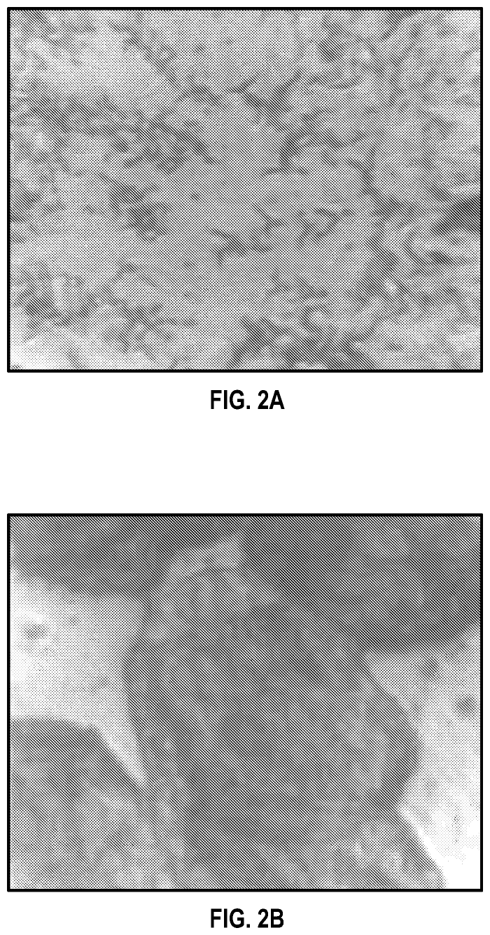

FIGS. 2A and 2B are images of biological species captured with a monochrome CCD sensor (specifically, a Videology 21D379H.4 sensor), used without any ultraviolet-blocking filters, of an example ultraviolet microscopy system operating at a wavelength of 275 nm. Illumination non-uniformities in the sample plane were corrected in the software by taking a flat field image. The numerical aperture of the system was better that 0.1. FIG. 2A shows Halobacteria Salinarium cells, imaged with a 2 mm fused-quartz ball objective lens. FIG. 2B shows cheek cells, imaged with a 4 mm fused-quartz half-ball objective lens. In addition to having good resolution, the images provide high image contrast. In particular, with reference to FIG. 2A, the unlabeled bacteria exhibit high contrast against the background, resulting from the strong absorption of the deep ultraviolet light by proteins and nucleic acids. With a visible-light transmission microscope, it would be very hard to see the bacteria without labeling them or using rather expensive phase contrast systems, as bacteria are almost transparent to visible light.

In some embodiments, as noted, the sensor 114 may be a CMOS sensor. CMOS sensors are commonly found in webcams, which are widely accessible and affordable. An unmodified webcam, however, usually has several elements or layers that make it insensitive to deep ultraviolet light, such as one or more glass filters to block infrared and ultraviolet light, and a Bayer filter mosaic on top of the sensor array, consisting of red, green, and blue color filters. It is possible to remove these layers from the sensor, thereby greatly enhancing the sensitivity of the sensor in the ultraviolet wavelength region. The filter layers can be removed chemically without damaging the underlying sensor; suitable chemicals for this purpose are well-known to those of ordinary skill in the art. Alternatively, the filter layers can also be removed mechanically.

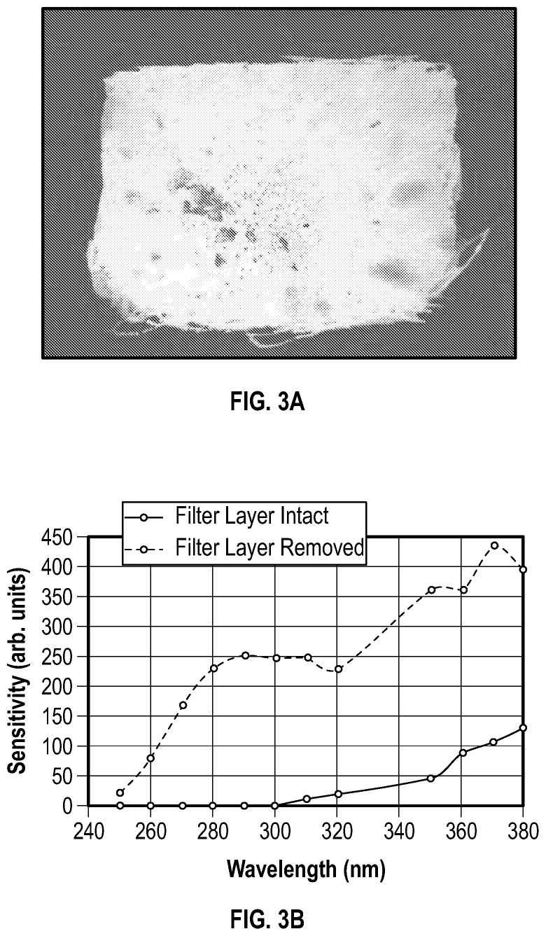

FIG. 3A is an image, taken under 275 nm illumination, of a webcam sensor with the Bayer and other filter layers partially removed. As can be seen, in the peripheral areas where the filter layers are intact, no ultraviolet light is reaching the detector, and these areas are therefore dark. However, the center area where the filter layers were removed is very bright, showing highly increased sensitivity to the 275 nm deep ultraviolet light. FIG. 3B is a graph showing the spectral sensitivity to ultraviolet light of the webcam sensor with the filter layers removed, compared with the spectral sensitivity of the webcam sensor with the filter layers present and intact. To compare the spectral sensitivity, the filter layers were first partly removed from the top of the sensor. The sensor was then illuminated with several different wavelengths of ultraviolet light using a monochromator and a xenon lamp as the light source. Care was taken to illuminate the sample uniformly, and bandpass filters were placed at the monochromator output to eliminate interference from higher spectral orders. The output of pixels where the filter layers were removed was compared against the output of pixels where the filter layers were intact. The output power at every wavelength was measured using a photodetector with a known sensitivity curve.

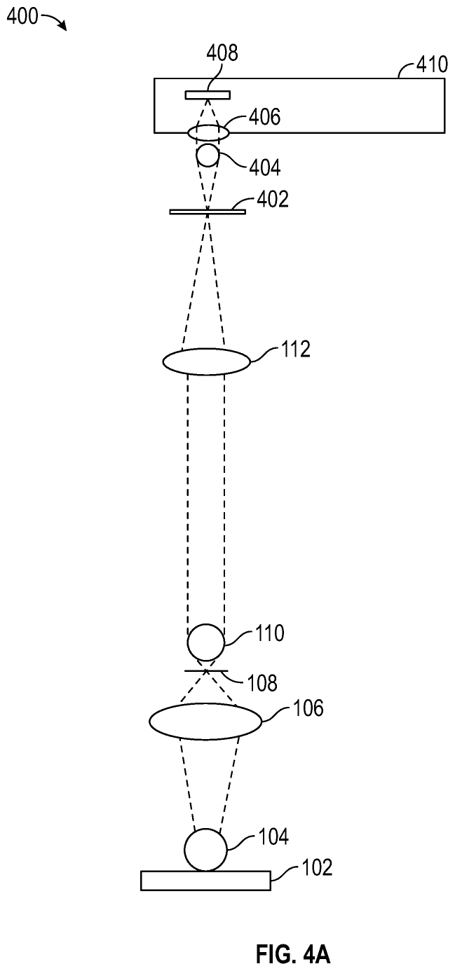

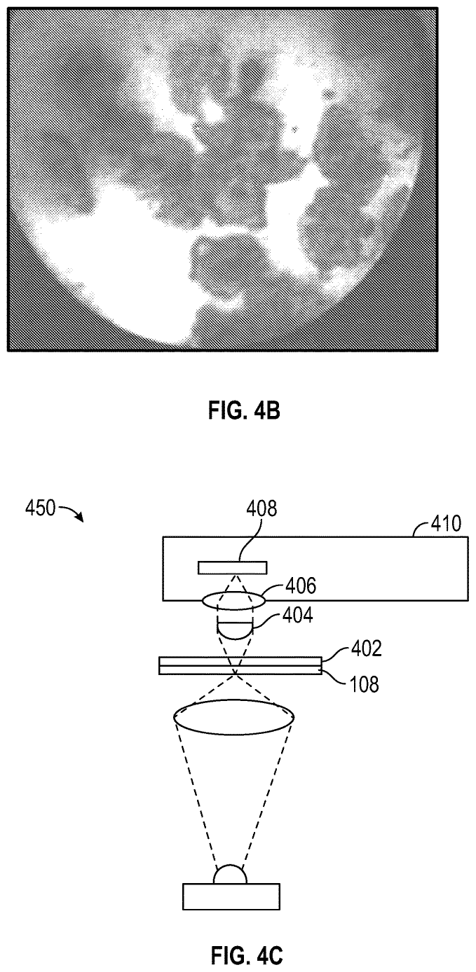

FIG. 4A is a schematic diagram of an example deep ultraviolet microscopy system 400 utilizing a fluorescent screen in conjunction with an electronic image sensor sensitive in the visible regime, in accordance with various embodiments. In this system 400, which is otherwise similar to the system 100 of FIG. 1A, the electronic image sensor 114 at the image plane of the microscope has been replaced by a fluorescent screen 402, which converts the deep ultraviolet image into a visible-light image.

In a simple embodiment, the fluorescent screen may be a piece of white paper, which fluoresces under ultraviolet light. Such a paper screen can blur the image due to the texture of the paper; this effect can be reduced by removing the tube lens 112 to obtain higher magnification. Alternatively, a ZnS:Ag screen, which fluoresces blue under ultraviolet illumination, may be used; such screens are commonly used to image scintillations from alpha particles. The texture of the fluorescent screen generally affects the resolution of the deep ultraviolet microscopic images. However, there are several fluorescent screens available, such as those used for x-ray imaging or for cathode-ray tubes (CRTs), that are coated on smooth surfaces and therefore have very little texture, which allows eliminating the resolution limit due to screen texture.

The visible-light image of the sample that is created on the fluorescent screen can, in turn, be imaged with a suitable arrangement of lenses 404, 406 onto an electronic sensor 408 sensitive in the visible regime. In some embodiments, a regular camera, including an image sensor 408 and associated lens 406, is used, optionally in conjunction with a ball lens 404. The camera may, for instance, be a cellphone camera, which can be used as is, without any modifications. Thus, a microscope equipped with an ultraviolet light source and a fluorescent screen, and modified with ultraviolet-transmissive lenses, can be augmented by the camera integrated in a conventional cellphone 410 to provide a deep ultraviolet microscopy system.

FIG. 4B is an image of unlabeled cheek cells, taken with an example ultraviolet microscopy system including a fluorescent screen (specifically a ZnS:Ag screen) imaged with a cellphone camera, in accordance with one embodiment.

FIG. 4C is a schematic diagram of a more compact example deep ultraviolet microscopy system 450 utilizing a fluorescent screen in conjunction with an electronic image sensor sensitive in the visible regime, in accordance with various embodiments. In this configuration, the fluorescent screen 402 is placed directly adjacent to the sample 109 disposed on the sample substrate slide 108 (such that the sample 109 is sandwiched between the sample substrate 108 and the fluorescent screen 402), and the objective and tube lenses 110, 112 are, accordingly, omitted. As in FIG. 4A, the visible light generated by the fluorescent screen 402 is imaged, e.g., with a ball or half-ball lens 404, onto a camera, such as a cellphone camera.

In some embodiments, a microscopy system otherwise similar to the system 100 and microscope 150 of FIGS. 1A and 1B utilizes photographic paper or film as the ultraviolet detector, in lieu of an electronic image sensor 114. Conventional black-and-white photographic paper possesses high sensitivity in the ultraviolet region of the spectrum, and as such provides an affordable and convenient means for capturing and permanently recording deep ultraviolet microscopic images. In one example implementation, a Kodak Brownie box camera was modified by removing its lens and adding an attachment that slides into the microscope tube, thereby attaching the box camera firmly to the body 152 of the microscope. To focus the image, a fluorescent screen was temporarily placed on the image plane. The fluorescent screen was subsequently replaced by photographic paper (specifically, Arista Edu Ultra VC RC, although other photographic papers or films may alternatively be used). To prevent accidental exposure of the photographic paper, the replacement took place under red light illumination. After the photographic paper was loaded, an image was recorded under ultraviolet illumination of a sample by operating the shutter of the camera in the conventional manner and exposing the paper for about 25 milliseconds. The exposed paper was developed in conventional black-and-white developer (specifically Kodak Dektol) and fixed in a hype (sodium thiosulphate) solution. As will be readily appreciated by those of ordinary skill in the art, various details of the described system configuration and process for exposing and developing the photographic paper or film may be changed without deviating from the general concept of ultraviolet microscopy with photographic paper. For instance, the photographic paper may be affixed to or positioned relative to the microscope body by other means, or alternative solutions for image development and fixation may be used. Regardless of implementation details, photographic papers are a cost-effective and straightforward means for recording deep ultraviolet microscopic images.

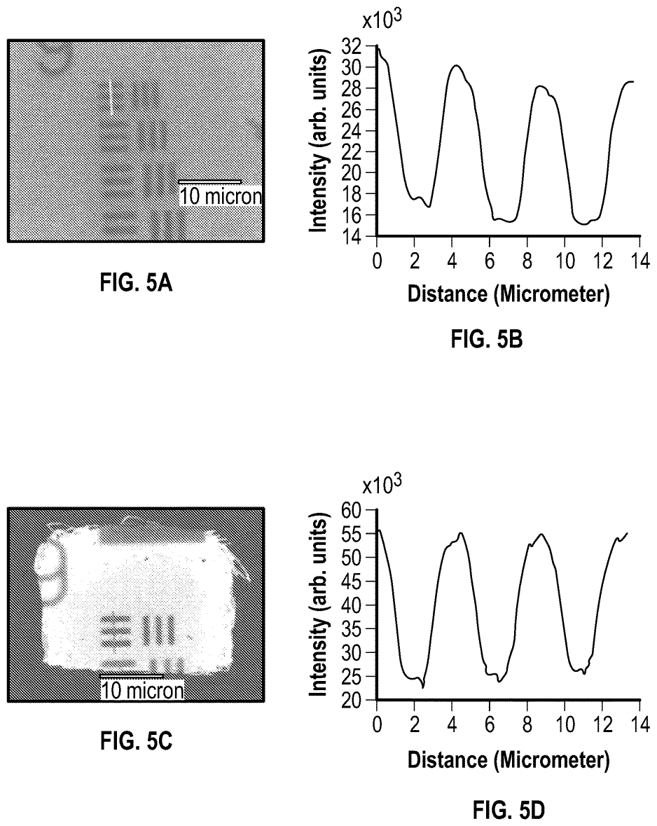

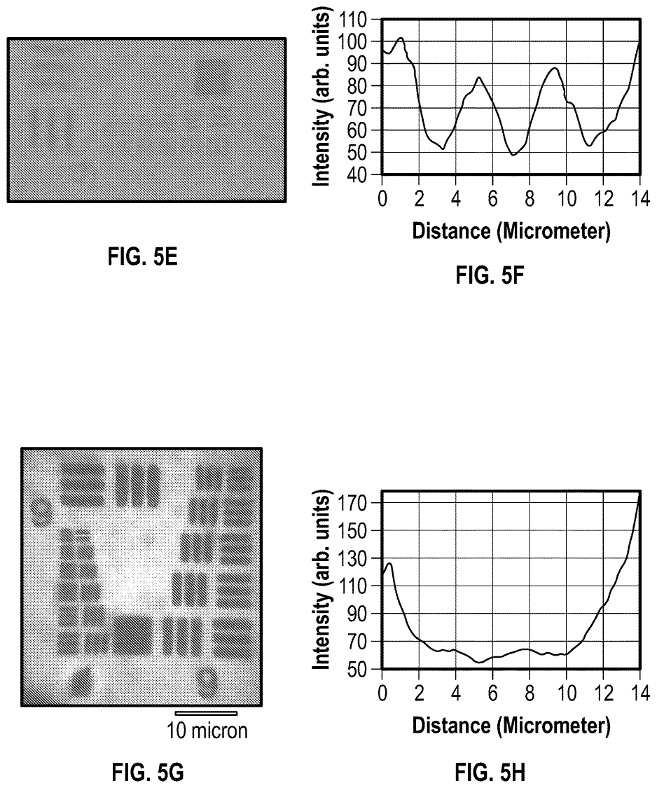

FIGS. 5A-5H show images (FIGS. 5A, 5C, 5E, 5G) and associated line profiles (FIGS. 5B, 5D, 5F, 5H) of a fused-silica USAF1951 resolution target, acquired with ultraviolet microscopy systems utilizing as their respective detectors a CCD sensor, a CMOS webcam sensor stripped of its filter layers, a cellphone camera imaging a fluorescent screen, and photographic paper, in accordance with the above-described embodiments. The images were taken with ultraviolet illumination at 275 nm.

FIG. 5A shows the image of the USAF resolution target as taken with a system 100 or microscope 150 (generally as described above with reference to FIGS. 1A and 1B) including an ultraviolet-sensitive monochrome CCD camera and a ball lens objective that is 2 mm in diameter. FIG. 5B shows the intensity profile across the set of lines with the smallest separation. As can be seen, all the lines up to the sixth element of the seventh group, corresponding to the smallest separation in this target with a linewidth of 2.19 microns, can be resolved. Based on this data, the resolving power of this microscope is better than 0.5 microns, which gives a numerical aperture of the system better than 0.35. The numerical aperture can be further improved by utilizing ball lenses of smaller diameter.

FIGS. 5C and 5D show the image and line profile of the USAF resolution target as taken with a system 100 or microscope 150 including a modified webcam CMOS sensor. Here, too, all lines are clearly resolved. Owing to the fact that the webcam sensor is smaller in size than the CCD sensor, the field of view (about 140 μm×180 μm for a 4 mm half-ball objective lens, and 60 μm×78 μm for a 2 mm ball lens objective) is also smaller with the webcam.

FIGS. 5E and 5F show the image and line profile of the USAF resolution target as taken with a system 400 including a fluorescent screen imaged by a cellphone camera. White printer paper was used as the fluorescent screen. Despite the paper texture blurring the image, all lines in the seventh group could still be resolved.

FIGS. 5G and 5H show the image and line profile of the USAF resolution target as taken with a system including photographic paper as the detector. The negative image was scanned at 1200 dpi resolution using an HP 4630 scanner, and then inverted in GIMP software. Despite some reduction in contrast, which is attributable to scanning artifacts and a small amount of camera shaking during manual operation of the camera shutter, it is possible to clearly resolve all the elements of the seventh group of the test target.

In some embodiments, as yet another means for recording deep ultraviolet microscopic images, paper coated with cyanotype chemicals, such as potassium ferricyanide (K₃[Fe(CN)₆]³⁻) or ferrous ammonium citrate ((NH₄)₅[Fe(C₆H₄O₇)₂]), is used as the detector in place of an electronic image sensor. Cyanotype chemicals have high sensitivity to deep ultraviolet light. Due to the very low cost of these chemicals and ease of processing, which involves simply washing the paper under water after exposure to the UV light, such paper media are suited, in particular, for teaching purposes. Cyanotype deep ultraviolet images can be made using contact printing techniques, where the sample is placed in contact with the cyanotype paper, sandwiched between the sample substrate and the cyanotype paper, while being illuminated by ultraviolet light through the sample substrate.

Described herein are various embodiments of compact, affordable microscopy instruments and systems, constructed from widely available and inexpensive components, that facilitate recording deep ultraviolet microscopic images. Such compact ultraviolet microscopes may find multiple applications, including acquiring biomolecular spectra for the identification and quantification of biological species at ultra-low volumes, concentrations, and micron sizes for the study of protein crystals and lignins, as well as high-contrast observations of biological cells and molecules.

The following examples are illustrative embodiments:
1. An ultraviolet microscopy system including: an ultraviolet light source to emit ultraviolet radiation over a narrow wavelength band; a system of ultraviolet-transmissive lenses made of fused silica or quartz, comprising one or more lenses to illuminate a sample with the emitted ultraviolet radiation, at least a portion of the emitted ultraviolet radiation being transmitted through the sample; and an ultraviolet-sensitive detector placed in a path of the transmitted ultraviolet radiation.
2. The system of example 1, wherein the ultraviolet light source comprises a deep ultraviolet light emitting diode (LED).
3. The system of example 2, wherein the narrow wavelength band has an associated full width at half maxima (FWHM) of no more than 15 nm and is located within a wavelength range from 200 nm to 300 nm.
4. The system of example 1, wherein the ultraviolet light source comprises a deuterium or xenon lamp and a monochromator at an output of the deuterium or xenon lamp, the deuterium or xenon lamp emitting ultraviolet radiation over a broad wavelength band, and the monochromator configured to limit the ultraviolet radiation output by the ultraviolet light source to a narrow wavelength band.
5. The system of example 4, wherein the monochromator is further configured to scan the narrow wavelength band across the broad wavelength band.
6. The system of any of examples 1-5, wherein the system of ultraviolet-transmissive lenses comprises: a ball or half-ball collimating lens to collimate the emitted ultraviolet radiation; and a condenser lens to direct the collimated ultraviolet radiation onto the sample.
7. The system of example 6, wherein the system of ultraviolet-transmissive lenses further comprises a ball or half-ball objective lens to focus the transmitted ultraviolet radiation onto the ultraviolet detector.
8. The system of example 6, wherein the system of ultraviolet-transmissive lenses further comprises an objective lens and a tube lens to image the transmitted ultraviolet radiation onto the ultraviolet detector.
9. The system of any of examples 1-8, wherein the ultraviolet detector comprises a monochrome ultraviolet-sensitive charge-coupled device (CCD) sensor.
10. The system of any of examples 1-8, wherein the ultraviolet detector comprises an ultraviolet-sensitive complementary metal-oxide-semiconductor (CMOS) sensor.
11. The system of example 10, wherein the ultraviolet-sensitive CMOS sensor is obtained from a web-camera detector by removal of at least one of an ultraviolet blocking layer, an infrared blocking layer, or a Bayer filter layer.
12. The system of any of examples 1-8, wherein the ultraviolet detector comprises a photographic paper or film.
13. The system of any of examples 1-6, wherein the ultraviolet detector comprises an ultraviolet-sensitive fluorescent screen and a visible-light camera placed to acquire an image of the fluorescent screen.
14. The system of example 13, wherein the camera is a cellphone camera.
15. The system of example 13 or example 14, wherein the system of ultraviolet-transmissive lenses further comprises one or more lenses to image the transmitted ultraviolet radiation onto the fluorescent screen.
16. The system of example 13 or example 14, wherein the fluorescent screen is placed adjacent to the sample.
17. The system of any of examples 1-6, further comprising a cyanotype-coated paper placed in contact with the sample.
18. An ultraviolet microscopy system, comprising: an ultraviolet light source to emit ultraviolet radiation; a system of ultraviolet-transmissive lenses, comprising one or more lenses to illuminate a sample with the emitted ultraviolet radiation, at least a portion of the emitted ultraviolet radiation being transmitted through the sample; a fluorescent screen placed in a path of the transmitted ultraviolet radiation; and a cellphone camera placed to acquire an image of the fluorescent screen.
19. An ultraviolet microscopy method of detecting micro-size biological species, the method comprising: illuminating a sample including the micro-size biological species with deep ultraviolet radiation; capturing deep ultraviolet radiation transmitted through the sample to create an image; and detecting the micro-size biological species in the image.
20. The method of example 19, wherein the transmitted ultraviolet radiation is captured by a monochrome ultraviolet-sensitive CCD sensor or an ultraviolet-sensitive CMOS sensor.
21. The method of example 19, wherein the transmitted ultraviolet radiation is captured by a fluorescent screen and the image is an image of the fluorescent screen acquired by a visible-light camera.
22. The method of example 19, wherein the transmitted ultraviolet radiation is captured by a photographic paper.
23. The method of example 19, wherein the transmitted ultraviolet radiation is captured by cyanotype-coated paper placed in contact with the sample.
24. The method of any of examples 19-23, wherein the micro-size biological species comprise at least one of bacteria, fungi, viruses, protein crystals, or DNA or RNA.

Although embodiments have been described with reference to specific example embodiments, it will be evident that various modifications and changes may be made to these embodiments without departing from the broader scope of the invention. Accordingly, the specification and drawings are to be regarded in an illustrative rather than a restrictive sense.

What is claimed is: TITLE: COMPACT DEEP ULTRAVIOLET MICROSCOPE IN THE CLAIMS PLEASE AMEND THE CLAIMS AS FOLLOWS:

1. An ultraviolet microscopy system, comprising:
an ultraviolet light source to emit ultraviolet radiation over a narrow wavelength band;
a system of ultraviolet-transmissive lenses made of fused silica or quartz, comprising one or more lenses to illuminate a sample with the emitted ultraviolet radiation, at least a portion of the emitted ultraviolet radiation being transmitted through the sample; and
an ultraviolet-sensitive detector placed in a path of the transmitted ultraviolet radiation.

2. The system of claim 1, wherein the ultraviolet light source comprises a deep ultraviolet light emitting diode (LED).

3. The system of claim 2, wherein the narrow wavelength band has an associated full width at half maxima (FWHM) of no more than 15 nm and is located within a wavelength range from 200 nm to 300 nm.

4. The system of claim 1, wherein the ultraviolet light source comprises a deuterium or xenon lamp and a monochromator at an output of the deuterium or xenon lamp, the deuterium or xenon lamp emitting ultraviolet radiation over a broad wavelength band, and the monochromator configured to limit the ultraviolet radiation output by the ultraviolet light source to a narrow wavelength band.

5. The system of claim 4, wherein the monochromator is further configured to scan the narrow wavelength band across the broad wavelength band.

6. The system of claim 1, wherein the system of ultraviolet-transmissive lenses comprises:
a ball or half-ball collimating lens to collimate the emitted ultraviolet radiation; and
a condenser lens to direct the collimated ultraviolet radiation onto the sample.

7. The system of claim 6, wherein the system of ultraviolet-transmissive lenses further comprises a ball or half-ball objective lens to focus the transmitted ultraviolet radiation onto the ultraviolet detector.

8. The system of claim 6, wherein the system of ultraviolet-transmissive lenses further comprises an objective lens and a tube lens to image the transmitted ultraviolet radiation onto the ultraviolet detector.

9. The system of claim 1, wherein the ultraviolet detector comprises a monochrome ultraviolet-sensitive charge-coupled device (CCD) sensor.

10. The system of claim 1, wherein the ultraviolet detector comprises an ultraviolet-sensitive complementary metal-oxide-semiconductor (CMOS) sensor.

11. The system of claim 10, wherein the ultraviolet-sensitive CMOS sensor is obtained from a web-camera detector by removal of at least one of an ultraviolet blocking layer, an infrared blocking layer, or a Bayer filter layer.

12. The system of claim 1, wherein the ultraviolet detector comprises a photographic paper or film.

13. The system of claim 1, wherein the ultraviolet detector comprises an ultraviolet-sensitive fluorescent screen and a visible-light camera placed to acquire an image of the fluorescent screen.

14. The system of claim 13, wherein the camera is a cellphone camera.

15. The system of claim 13, wherein the system of ultraviolet-transmissive lenses further comprises one or more lenses to image the transmitted ultraviolet radiation onto the fluorescent screen.

16. The system of claim 13, wherein the fluorescent screen is placed adjacent to the sample.

17. The system of claim 1, further comprising a cyanotype-coated paper placed in contact with the sample.

18. An ultraviolet microscopy system, comprising:
an ultraviolet light source to emit ultraviolet radiation;
a system of ultraviolet-transmissive lenses, comprising one or more lenses to illuminate a sample with the emitted ultraviolet radiation, at least a portion of the emitted ultraviolet radiation being transmitted through the sample;
a fluorescent screen placed in a path of the transmitted ultraviolet radiation; and
a cellphone camera placed to acquire an image of the fluorescent screen.

19. An ultraviolet microscopy method of detecting micro-size biological species, the method comprising:
illuminating a sample including the micro-size biological species with deep ultraviolet radiation;
capturing deep ultraviolet radiation transmitted through the sample to create an image; and
detecting the micro-size biological species in the image.

20. The method of claim 19, wherein the transmitted ultraviolet radiation is captured by a monochrome ultraviolet-sensitive CCD sensor or an ultraviolet-sensitive CMOS sensor.

21. The method of claim 19, wherein the transmitted ultraviolet radiation is captured by a fluorescent screen and the image is an image of the fluorescent screen acquired by a visible-light camera.

22. The method of claim 19, wherein the transmitted ultraviolet radiation is captured by a photographic paper.

23. The method of claim 19, wherein the transmitted ultraviolet radiation is captured by cyanotype-coated paper placed in contact with the sample.

24. The method of claim 19, wherein the micro-size biological species comprise at least one of bacteria, fungi, viruses, protein crystals, or DNA or RNA.
